(19) United States
(12) Patent Application Publication
(10) Pub. No.: US 2014/0291428 A1
(43) Pub. Date: Oct. 2, 2014

(54) INSERT ARRANGEMENT FOR A ROLLER WEAR SURFACE

(71) Applicant: FLSmidth A/S, Valby (DK)

(72) Inventors: David Michael Sharman, Bethlehem, PA (US); Edward James Pownell, Midvale, UT (US)

(21) Appl. No.: 14/357,696

(22) PCT Filed: Dec. 18, 2012
(86) PCT No.: PCT/US12/70249

§ 371 Date: May 12, 2014

Related U.S. Application Data
(60) Provisional application No. 61/578,275, filed on Dec. 21, 2011.

(51) Int. Cl. B02C 4/30

(52) U.S. Cl. CPC B02C 4/305
USPC 241/278.1; 241/294; 29/895.21

(57) ABSTRACT

A roller for use in devices configured to comminute material has a wear surface. The wear surface comprises inserts that are spaced apart differently to provide a desired wear characteristic in the wear surface. In one embodiment, some inserts may also have diameters or widths that are smaller than other inserts. For example, columns of inserts adjacent an end of the roller may have diameters that are smaller or larger than inserts in columns located near the center of the roller or otherwise positioned between the two ends of the roller. As another example, a middle portion of the wear surface may have inserts that include inserts of a larger or smaller diameter than inserts adjacent the ends of the wear surface.

### CROSS-REFERENCE TO RELATED APPLICATIONS

The present application claims priority to U.S. Provisional Patent Application No. 61/578,275, which was filed on Dec. 21, 2011.

### FIELD OF THE INVENTION

The present invention relates to rollers for devices configured to comminute material such as ore, rock, minerals, stone, agglomerated material, cement clinker, or other material. Examples of such devices are roller mills, roller presses, and other types of crushing devices.

### BACKGROUND OF THE INVENTION

Some types of mills often include one or more rollers that roll to crush material against a grinding surface. The grinding surface may be an anvil, a table or a rotatable table below the rotating rollers. Other types of crushing devices, such as roller presses, may have rollers that are spaced apart from each other to define a nip. Material may be crushed or otherwise comminuted in the nip by the rotation of the rollers. Examples of such crushing devices may be seen from U.S. Pat. Nos. 7,954,743, 7,946,518, 7,637,446, 7,510,135, 5,542,618, and 4,382,561.

Rollers of crushing devices may have an outer surface used to compact and comminute material. Rollers may include a liner that defines the outer surface of the roller. The outer surface is typically formed of metal and experiences wear during operation of the roller. Inserts, which may also be referred to as studs, may be positioned in the wear surface of the roller. The inserts may be composed of a material that is harder than other portions of the surface such as the liner of the roller or the outer surface of the roller. For instance, the inserts may be composed of carbide or tungsten carbide. U.S. Pat. Nos. 5,269,477, 5,203,513, and 412,558 disclose examples of the use of inserts in wear surfaces of a roller used for comminuting material.

Rollers often experience relatively high rates of wear and, as a result, often have the wear surfaces of such rollers replaced or repaired. When such replacement or repairing is needed, substantial costs in terms of lost operational capacity as well as the costs associated with the repair or replacement of the roller can be experienced by an operator of a crushing device. A new design for a roller used in such crushing devices is needed that improves the wear characteristics of rollers to reduce the need for repairs and increase the life of the roller wear surface.

### SUMMARY OF THE INVENTION

A roller for a crusher device such as, for example, a roller press or a roller mill, is provided as well as a crusher device that utilizes at least one of such a roller. The roller may include a body that has a first end, a second end opposite the first end, and a wear surface that extends between a position adjacent the first end to a position adjacent the second end. A plurality of inserts, or studs, may be positioned in the wear surface. The inserts or studs may extend out of the wear surface or may define a portion of the wear surface. The inserts may be arranged in any of a number of ways.

In some embodiments, the inserts may be arranged in multiple columns that extend along the circumference of the wear surface. The columns may include a first column of first inserts, a second column of second inserts, and a third column of third inserts. A first insert of the first column, a second insert of the second column and a third insert of the third column may be positioned within a first row of inserts that extend along the width of the wear surface. The width of the wear surface may be defined by an edge of the wear surface adjacent the first end and an edge of the wear surface adjacent the second end. The first insert of the first row may be spaced apart from the second insert of the first row by a first distance and the second insert of the first row may be spaced apart from the third insert of the first row by a second distance that is greater than or less than the first distance.

In some embodiments, there may be additional columns of inserts. For instance, there may be a fourth column of fourth inserts, a fifth column of fifth inserts, a sixth column of sixth inserts, a seventh column of seventh inserts, an eighth column of eighth inserts, a ninth column of ninth inserts, a tenth column of tenth inserts, an eleventh column of eleventh inserts and a twelfth column of twelfth inserts. Each of such columns of inserts may have an insert positioned in the first row such that spacing between immediately adjacent inserts in the row differ for at least some of the inserts. For example, a fourth insert of the fourth column of inserts in the first row may be located spaced apart from the third insert of the first row by a third distance that is greater than or less than the first distance. As another alternative, a seventh insert, an eighth insert, a ninth insert, a tenth insert and an eleventh insert may be positioned in a second row immediately adjacent to the first row. The inserts of the second row may be spaced apart from inserts to which they are immediately adjacent by different distances than the distances used in the first row or may utilize a similar spacing arrangement but merely be offset relative to the alignment of inserts of the first row. Of course, the inserts of the second row may be spaced from the first row to provide other differing spaced arrangement between inserts at the ends of the wear surface relative to the middle portions of the wear surface.

As another alternative, some columns of inserts may be in the first row while other inserts of other columns may define a second row that is adjacent to or immediately adjacent to the first row of inserts. As yet another alternative, some columns of inserts may be used to define a number of different rows of inserts. In some embodiments, the pattern of rows defined by the different columns of inserts may be configured to repeat itself along the circumference of the roller wear surface.

The columns of inserts may be spaced apart by different spacing. For example, intercolumn spacing between immediately adjacent columns of inserts may be different for different columns of inserts. Additionally, the spacing between immediately adjacent inserts within a column may also differ for different columns of inserts. For example, the intracolumn spacing of inserts for a first column of inserts may be less or more than spacing between immediately adjacent inserts in a second column of inserts. The intracolumn spacing may be used to define interrow spacing of distances between immediately adjacent rows of inserts. The intercolumn spacing may be utilized to define intrarow spacing between inserts within a same row of inserts.

Embodiments of the roller may utilize any of a number of different sized inserts. For example, a column of inserts may have one or multiple diameter or width sized inserts. As another example, a row of inserts may utilize inserts having just on width or diameter or may utilize different sized inserts having different widths or diameters.

A method of making a roller for a crushing device is also provided. That method may include offering to build a crushing device, assessing grinding forces, feed material sizing, and other parameters of the material to be comminuted by the crushing device, making calculations to determine parameters of the crushing device needed for comminuting the material, determining a desired throughput rate for the crushing device, analyzing parameters of the material after being comminuted in a testing device, assessing wear characteristics of rollers for the crushing device, designing the rollers to have a wear surface to account for the analyzed parameters and making the rollers.

Embodiments of the roller may be configured for one of a roller press and a roller mill. The roller may comprise a body having a bore that may receive a portion of at least one axle about which the roller is rotatable to grind material or otherwise comminute material. The body may also have a wear surface and inserts positioned in the wear surface. The insert may include first inserts in a first region of the wear surface located adjacent the first end of the body, second inserts located in a second region of the wear surface located adjacent the second end of the body, and third inserts located in a third region of the wear surface between the first and second inserts. Each of the first inserts may be positioned away from immediately adjacent other first inserts by a first distance. Each of the second inserts may be positioned away from immediately adjacent other second inserts by the first distance. Each of the third inserts may be positioned away from other immediately adjacent third inserts by a second distance that is less than or greater than the first distance.

The first inserts may include inserts of one size or type having just one width or diameter or multiple different types or sizes of inserts having differing widths or diameters. The second and third inserts may also include inserts of one size or type having just one width or diameter or multiple different types or sized inserts having differing widths and diameters.

Embodiments of the roller may also be configured to include fourth inserts in a fourth region located between the first and third regions and fifth inserts located in a fifth region that is positioned between the second and third regions. The fourth inserts may be spaced apart from other immediately adjacent fourth inserts by a third distance and each of the fifth inserts may be spaced apart from immediately adjacent other fifth inserts by the third distance. The third distance may be greater than or less than at least one of the first distance and the second distance. The third distance may be greater than the first distance and also may be greater than the second distance. Alternatively, the third distance may be less than the first distance and also less than the second distance. In yet other embodiments, the third distance is greater than one of the first distance and second distance and less than the other of the first and second distances.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of crushing devices and rollers having wear surfaces that may be used in such devices are shown in the accompanying drawings and certain present preferred methods of practicing the same are also illustrated therein. It should be appreciated that like reference numbers used in the drawings may identify like components.

FIG. 1 is a three dimensional image of a first embodiment of a crushing device.

FIG. 2 is a cross sectional view of a second embodiment of a crushing device.

FIG. 3 is a perspective view of a first present preferred roller that may be used in embodiments of the crushing device.

FIG. 4 is a perspective view of a second present preferred roller that may be used in embodiments of the crushing device.

FIG. 5 is a perspective view of a third present preferred roller that may be used in embodiments of the crushing device.

FIG. 6 is a perspective view of a fourth present preferred roller that may be used in embodiments of the crushing device.

FIG. 7 is a perspective view of a fifth present preferred roller that may be used in embodiments of the crushing device.

FIG. 8 is a schematic view of a row of inserts arranged along the width of a roller to illustrate a first material compaction pattern that an embodiment of the roller may be designed to generate when operated to comminute material.

FIG. 9 is a schematic view of a row of inserts arranged along the width of a roller to illustrate an alternative intrarow spacing of inserts that may be used in embodiments of a roller usable in embodiments of a crushing device.

FIG. 10 is a perspective view of a sixth present preferred roller that may be used in embodiments of the crushing device.

FIG. 11 is a perspective view of a seventh present preferred roller that may be used in embodiments of the crushing device.

FIG. 12 is a perspective view of an eighth present preferred roller that may be used in embodiments of the crushing device.

FIG. 13 is a cross sectional view taken along line XIII-XIII in FIG. 2 illustrating exemplary rollers having insert arrangements provided therein that have wear surfaces that define intermeshing or mating wear surface profiles as the rollers wear from comminution operations.

FIG. 14 is a cross sectional view of an exemplary embodiment of the roller that is configured to define a first autogenous layer profile during comminution operations.

FIG. 15 is a cross sectional view of an exemplary embodiment of the roller that is configured to define a second autogenous layer profile during comminution operations.

FIG. 16 is a cross sectional view of an exemplary embodiment of the roller that is configured to define a third autogenous layer profile during comminution operations.

### DETAILED DESCRIPTION OF PRESENT PREFERRED EMBODIMENTS

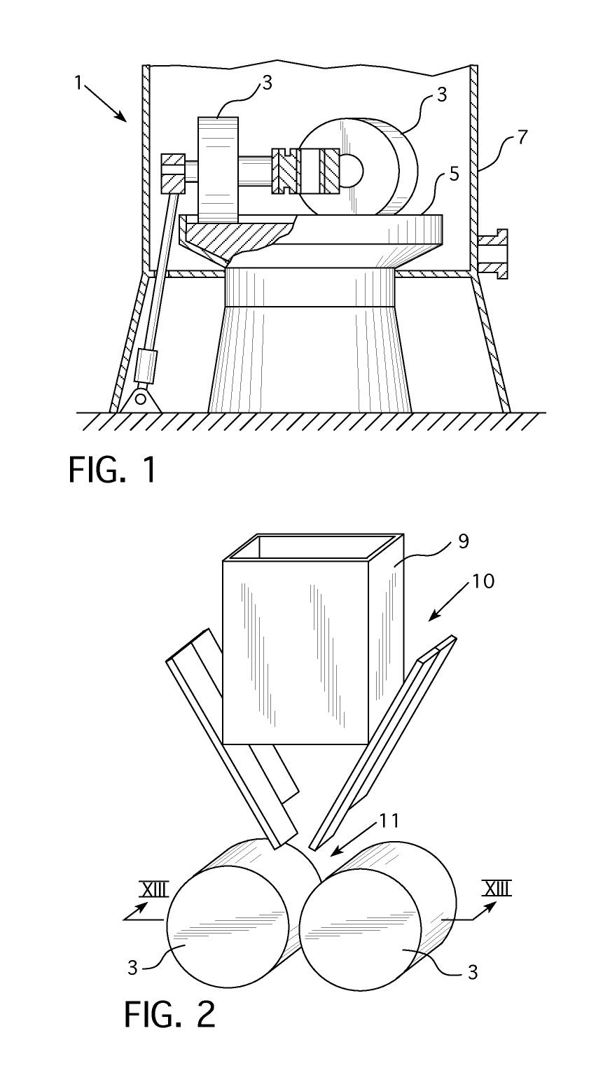

Referring to FIG. 1, a crushing device 1 may include a housing 7 that encloses a plurality of rollers 3 that rotate to comminute material such as ore, rock, mineral, stone, agglomerated material, or other material. Each of the rollers may have a central opening that receives a shaft about which the roller rotates. Material may be fed onto a table 5 on which the material is crushed by the rotating rollers to comminute material to a desired size or range of sizes.

Referring to FIG. 2, the crushing device 1 may alternatively be configured to include a housing that encloses and supports a plurality of spaced apart rollers 3. Two rollers 3 may be spaced apart from each other to define a nip 11. Material may be fed to the crushing device 1 via a feed mechanism 10 to feed material for being comminuted by the two rollers 3. The feed mechanism 10 may include a feed passageway 9 that defines an opening through which material may pass into the crushing device for being fed to the rollers for comminution.

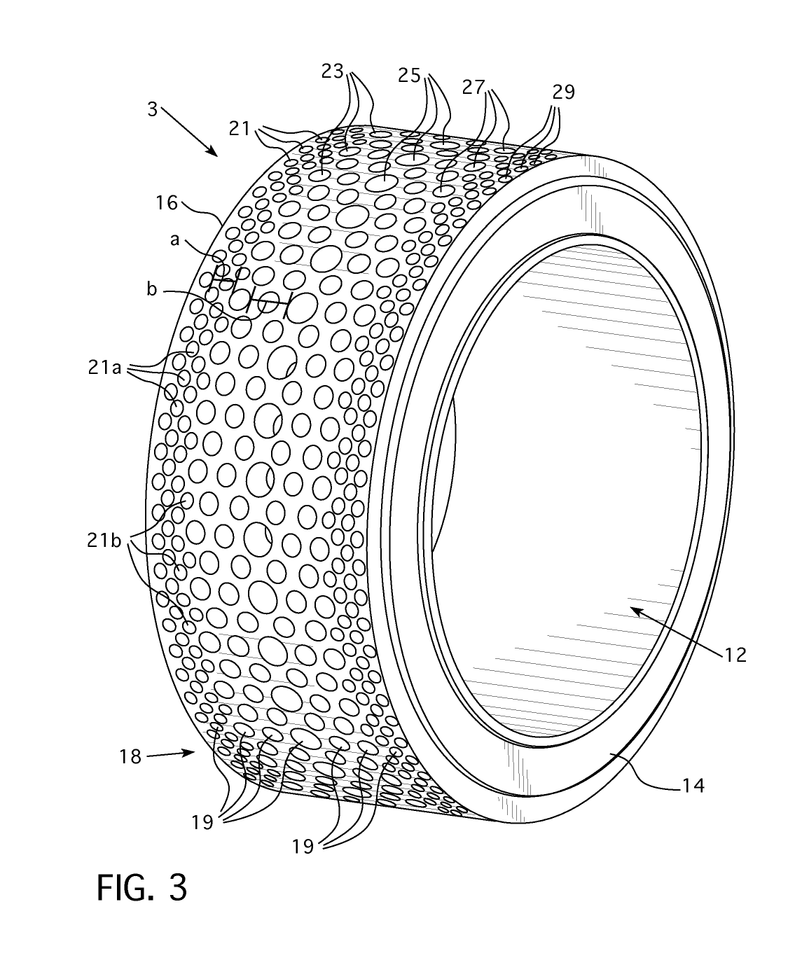

As shown in FIG. 3, rollers 3 may be cylindrical in shape or annular in shape. Preferably, the rollers have a central bore 12 for receiving a shaft about which the roller is rotatable. The roller may have a body that includes a first end 14 and a second end 16 that is opposite the first end 14. The roller 3 may include a wear surface that is along the circumference of the roller between the first and second ends of the roller 3. The wear surface may be the outmost portion of the roller or may be a liner that is attached to the roller.

The wear surface of the roller 3 is preferably composed of metal. A plurality of inserts, or studs, may be positioned in the wear surface. There may be a plurality of columns of inserts that extend in series along the circumference of the roller. Each column may have a width of just one series of inserts or may have a width of two or more series of inserts. For example, with reference to FIG. 3, a plurality of first inserts 21 may be aligned in series to define one column of inserts along the circumference of the roller adjacent the second end 16 of the roller. Alternatively, the column of first inserts could be three series wide by including a series of first inserts 21, a second series of first inserts 21a, and a third series of first inserts 21b.

The columns of inserts in the wear surface also define rows of inserts. For instance, as may be understood from FIG. 3, a row of inserts may include inserts from a plurality of different columns. For instance, inserts from a number of different columns may define the inserts from one row that extends along the width of the roller. One example of such a row is row 18, which has a plurality of inserts 19 from different columns in the row 18.

The inserts may be welded, fastened, adhered, or formed with the wear surface of the roller or with the roller body to connect the inserts to the roller for positioning the inserts in the wear surface. The inserts are preferably harder than the metal of the roller. For example, the inserts may be composed of industrial diamond, carbide, or tungsten carbide and the body of the roller and wear surface of the roller may be composed of austenitic steel or other types of steel.

With reference to FIGS. 3-13, different embodiments of rollers that may be fabricated for use in crushing devices such as roller mills and roller presses will proceed below. The embodiments of rollers shown or referenced in connection with FIGS. 3-12 and discussed below provide an explicit description of examples of different rollers for use in comminuting material that may be designed for use in crushing devices. It should be understood that a number of other design options may be utilized for arranging inserts within the wear surface of a roller beyond the examples explicitly discussed herein to meet a particular design objective while still being within the scope of one or more of the claims.

Referring to FIG. 3, a roller may have a plurality of columns of inserts. The columns of inserts may include a first column of first inserts 21, a second column of second inserts 23, a third column of third inserts 25, a fourth column of fourth inserts 27 and a fifth column of fifth inserts 29 positioned in the wear surface of the roller. The fifth inserts 29 may be positioned adjacent to the first end 14 of the roller and the first inserts 21 may be positioned adjacent the second end 16 of the roller. The second column of second inserts 23 may be positioned between the third column of third inserts 25 and first column of first inserts. The fourth column of fourth inserts 27 may be positioned between the third column of third inserts 25 and the fifth column of fifth inserts 29.

The diameter of the first inserts 21 may be the same as the diameter of the fifth inserts 29. The diameter of the second inserts 23 may be the same as the diameter of the fourth inserts 27. The diameter of the third inserts 25 may be larger than the diameter of either or both of the first 21 or second 23 inserts. The diameter of the second and fourth inserts 23, 27 may be larger than the diameter of the first and fifth inserts 21, 29. It should be understood that the diameter of the inserts may define the width of the inserts and that alternative embodiments the inserts may be polygonally shaped, such as rectangular shaped.

The first inserts 21 may be spaced apart from the second inserts 23 by a first distance a. The second inserts 23 may be spaced apart from the third inserts 25 by a second distance b. The fourth inserts 27 may also be spaced apart from the third inserts 25 by the second distance b. The fifth inserts 29 may be spaced apart from the fourth inserts 27 by the first distance a.

The first distance a may be less than or more than the second distance b. For instance, as shown, the first distance a may be less than the second distance b and preferably the spacing between inserts within a row of inserts is arranged so that the spacing between inserts near an end of the roller is smaller than the spacing between inserts positioned in the center of the roller.

The spacing between the columns of inserts and the size of the widths of the inserts may be selected to meet a particular design criteria for extending the wear life of the wear surface. For instance, in areas of the roller having a lower compaction pressure, a smaller spacing between adjacent columns of inserts could help mitigate autogenous layer migration. For many roller mill designs used for comminuting different types of material, there is typically lower grinding pressure along the edges of the roller relative to the center of the roller, which typically experiences higher grinding forces. Therefore, the spacing between inserts 19 of a row of inserts 18 may be arranged so that the spacing is narrower adjacent the first or second ends of the roller as compared to the spacing between inserts located in the center region of the roller between the ends of the roller.

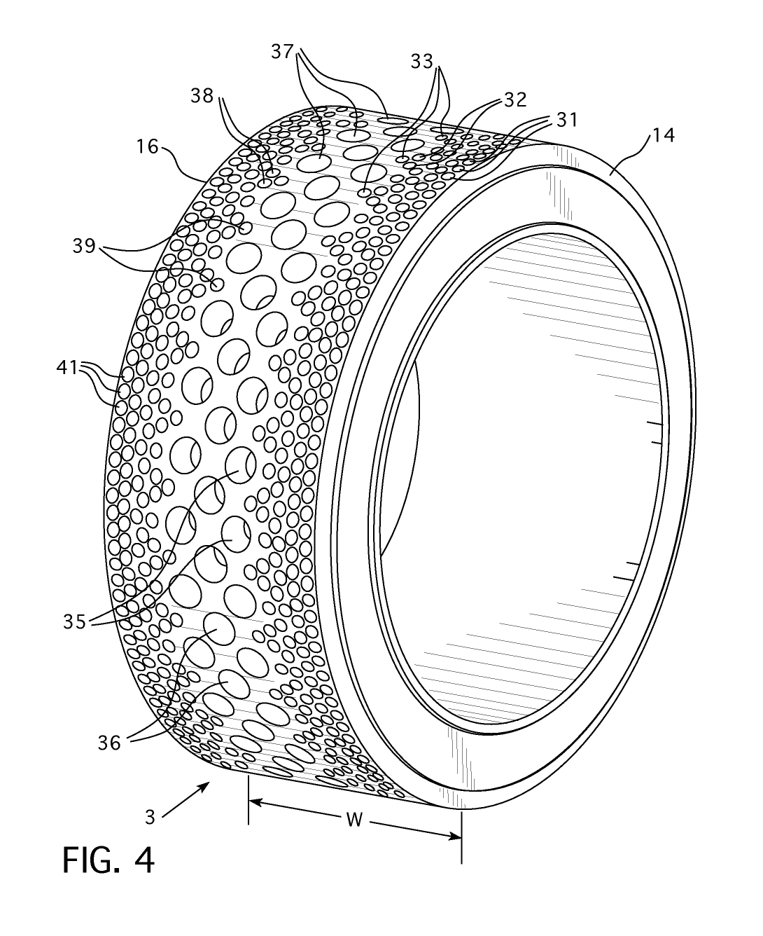

The spacing between inserts may also be changed for different rows or different columns of inserts. For instance, as may be appreciated from FIG. 4, different rows of inserts may include inserts that are spaced apart from immediately adjacent inserts at different spacings than rows immediately above or below the row of inserts. As a result of such changes in intercolumn spacing, there may be more inserts in some rows than in other rows to provide a desired arrangement of inserts. Such rows of differently spaced inserts may be defined by the intracolumn spacing of inserts in the column of inserts and also the intercolumn spacing between adjacent columns of inserts.

Referring to FIG. 4, a wear surface of a roller may include an insert arrangement that has a first column of inserts 31 spaced apart from each other in series along the circumference of the wear surface adjacent the first end 14 of the roller. A second column of inserts 32 may be spaced apart from each other in series along the circumference of the wear surface and be positioned between the first column of inserts 31 and a third column of inserts 33 that are spaced apart from each other in series along the circumference of the wear surface. The spacing between the inserts of the third column of inserts 33 may be different than the spacing between the inserts of the second column of inserts 32. The spacing between the inserts of the second column of inserts 32 may differ from the spacing between the inserts of the first column of inserts and the spacing between the inserts of the first column of inserts 31 may differ from the spacing of the inserts of the third column of inserts 33.

A fourth column of spaced apart inserts 35 may be positioned along the circumference of the wear surface in series as well. The spacing between the inserts 35 of the fourth column may differ from the spacing used in each of the first, second, and third columns of inserts 31, 32, and 33. The fourth column of inserts 35 may be between the third column of inserts 33 and a fifth column of spaced apart inserts 36 that are arranged in series along the circumference of the wear surface. The fifth column of inserts 36 may be positioned between a sixth column of inserts 37 and the fourth column of inserts 35. The sixth column of inserts 37 may be arranged in series and be spaced apart from each other along the circumference of the wear surface. The intracolumn spacing for the immediately adjacent inserts of the fourth, fifth and sixth columns of inserts 35, 36 and 37 may each be spaced apart from each other by the same distance. The intercolumn spacing between the fourth and fifth columns of inserts 35 and 36 and the fifth and sixth column of inserts 36 and 37 may also be the same distance. The spacing of the inserts of the fifth column of inserts 36 may be arranged to be offset relative to the inserts of the fourth and sixth columns 35 and 37 so that inserts in the fifth column of inserts 36 are in different rows of inserts than inserts in the fourth and sixth columns 35 and 37. Inserts in the fourth and sixth columns of inserts 35 and 37 may be spaced and arranged so that these inserts are generally positioned in the same rows of inserts. While not shown, it is envisaged that inserts in the fourth, fifth, and sixth columns 35, 36, and 37 may be staggered circumferentially around the roller, so that any given row of inserts contains only one insert from any one of the fourth, fifth, and sixth columns 35, 36, and 37.

A seventh column of inserts 39 may be positioned between the sixth column of inserts 37 and an eighth column of inserts 38. The seventh and eighth column of inserts 39 and 38 may each include inserts that are aligned in series within each column and spaced circumferentially apart from each other. Inserts within the seventh column of inserts 39 may be spaced circumferentially apart from each other by a distance which is different than the intracolumn spacing between inserts within the eighth column of inserts 38. A ninth column of inserts 41 may be positioned adjacent the second end 16 of the roller and be adjacent to the eighth column of inserts 39 so that the eighth column of inserts 38 is between the seventh and ninth columns of inserts 39 and 41. The inserts of the seventh, eighth, and ninth columns of inserts 39, 38 and 41 may be aligned in series along the circumference of the wear surface.

The intracolumn spacing between immediately adjacent inserts within the ninth column of inserts 41 may be the same as the intracolumn spacing between immediately adjacent inserts within the first column of inserts 31. The intracolumn spacing between immediately adjacent inserts within the eighth column of inserts 38 may be the same as the intracolumn spacing used for the second column of inserts 32. The intracolumn spacing used between immediately adjacent inserts in the seventh column of inserts 39 may be the same as the intracolumn spacing used in the third column of inserts 33.

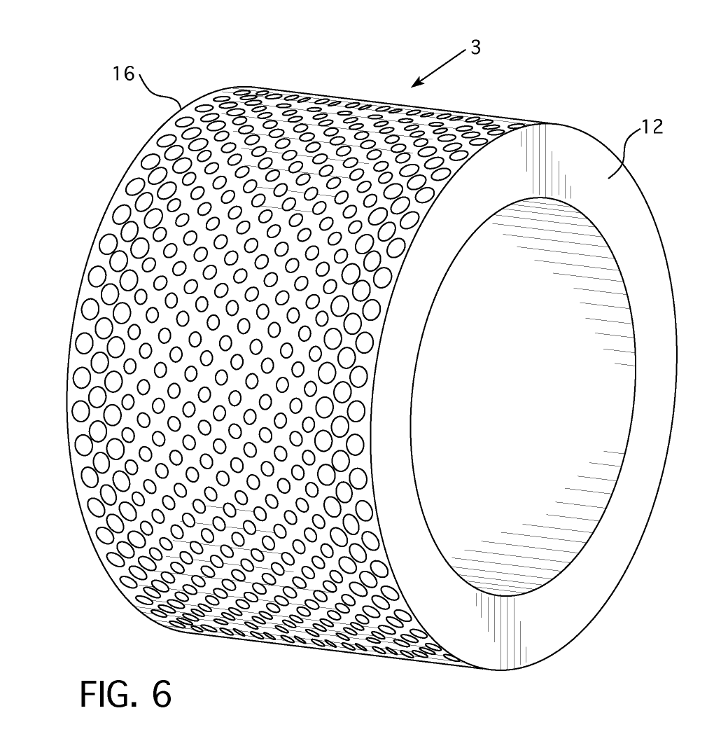

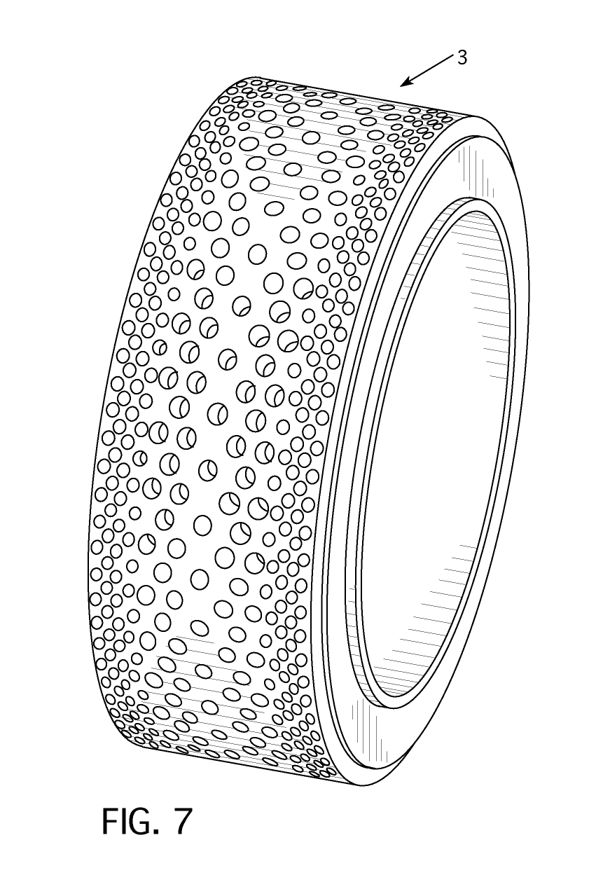

It should be understood that the width or diameter of the inserts for the different columns of inserts may also vary. For example, the inserts of the first, second, third, seventh, eighth and ninth columns of inserts 31, 32, 33, 39, 38 and 41 may all be of one width or diameter and the inserts of the fourth, fifth and sixth columns of inserts 35, 36, and 37 may all be the same size and be of a width or diameter that is larger than the other inserts. In alternative embodiments, the width or diameter of the inserts in the fourth and sixth columns of inserts 35 and 37 may be the same and may differ from the width or diameter of the inserts of the fifth column of inserts 36. FIGS. 3 and 7 illustrate examples of such an alternative embodiment. In yet other alternative embodiments, the widths of the inserts of the fourth, fifth and sixth columns of inserts 35, 36 and 37 may be smaller than the widths or diameters of the inserts of the other columns of inserts as may be appreciated from the alternative embodiment shown in FIG. 6.

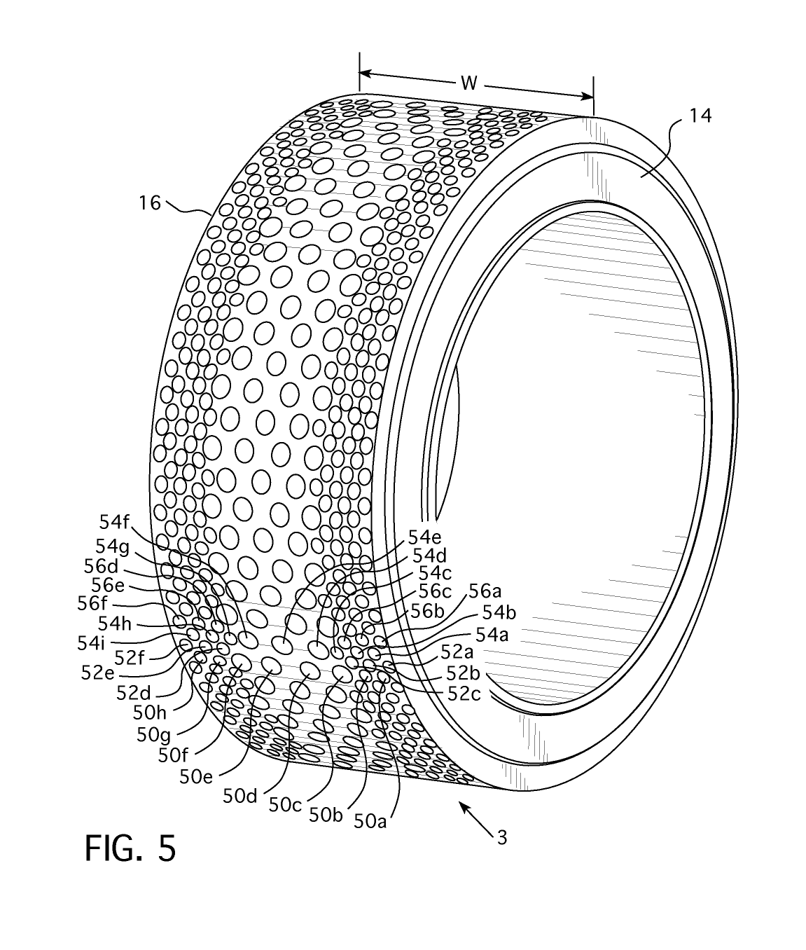

Referring to FIG. 5, a roller may include a wear surface that has a plurality of different columns of inserts that define different rows of inserts based on: a) the intracolumn spacing of inserts within each column, and b) the intercolumn spacing of inserts immediately adjacent to the other columns of inserts. Each row of inserts may extend along a linear series of inserts that extend along the width W of the wear surface such that each row includes a series of spaced apart inserts extending from a point adjacent the first end 14 of the roller to a point adjacent to the second end 16 of the roller.

For instance, a first row of inserts may include inserts 50a-50h. The row of inserts may include inserts from columns having a small diameter adjacent the first 14 and second 16 ends of the roller such as inserts 50a, 50b, 50g, and 50h. Inserts positioned in the center portion of the wear surface may have a width or diameter that is larger than these inserts, such as inserts 50c, 50d, 50e and 50f. The intercolumn spacing between the larger inserts 50c-50f may be greater than the intercolumn spacing between the smaller inserts 50a-50b and the intercolumn spacing between the smaller inserts 50g-50h. The intercolumn spacing between the smaller insert 50b and larger insert 50c and the intercolumn spacing between the larger insert 50f and the smaller insert 50g may be greater than or equal to the intercolumn spacing between the smaller inserts 50a-50b and 50g-50h. This same distance between the smaller insert 50b and larger insert 50c and between the larger insert 50f and the smaller insert 50g may also be smaller than the intercolumn spacing between the larger inserts such as the intercolumn spacing between inserts 50c-50d, inserts 50d-50e, and inserts 50e-50f.

Another second row of inserts 52a-52f immediately adjacent the first row of inserts 50a-50h may include a different number of inserts in that row and utilize a different number of smaller and larger inserts. The arrangement of the rows may be based on the intracolumn spacing for each column of inserts along with the intercolumn spacing between the different columns of inserts positioned in the wear surface of the roller. The second row of inserts 52a-52f may not utilize any larger diameter inserts and instead only include smaller inserts of a width or diameter similar to the diameter or width of the inserts 50a-50b and 50g-50h in the first row of inserts discussed above. The spacing between the inserts 52a-52b and 52b-52c may be the same as the spacing between inserts 52f-52e and 52d-52c. The spacing between inserts 52c and 52d, however, may be greater to account for not including any inserts in central portions of the roller. Greater intracolumn spacing within central columns of inserts defines larger pockets between adjacent inserts on the wear surface of the roller, thereby allowing the roller to receive and retain more autogenous layer material. More autogenous layer material reduces roller wear by creating more sacrificial area in areas of higher pressure where there is less concern over: a) the buildup of an autogenous layer, b) the sustained quality of an autogenous layer, and/or c) the migration or eventual degradation of an autogenous layer during comminution operations.

A third row of inserts 54a-54i may be immediately adjacent the second row so that the second row is between the first and third rows of inserts. A fourth row of inserts 56a-56f is immediately adjacent the third row of inserts 54a-54i such that the third row of inserts 54a-54i is between the fourth row of inserts 56a-56f and the second row of inserts 52a-52f.

The third row of inserts 54a-54i may include an arrangement of inserts that differs from the arrangement provided in the first row of inserts 50a-50h and also differ from the arrangement of inserts provided in the second row of inserts 52a-52f. The fourth row of inserts 56a-56f may be arranged and spaced similarly to the second row of inserts 52a-52f discussed above.

The third row of inserts may include inserts 54a-54c that are adjacent the first end of the roller 14 and inserts 54g-54i that are adjacent the second end 16 of the roller. Inserts 54d-54f are positioned in the center portion of the wear body and are offset relative to the inserts 50c-50f of the first row of inserts such that the inserts 54d-54f are in different columns of inserts than inserts 50c-50f. The intercolumn spacing between inserts 54d-54e and 54e-54f is greater than the intercolumn spacing between the inserts of smaller diameter located adjacent the first and second ends 14, 16 of the roller. For instance, the spacing between inserts 54a-54b and inserts 54b-54c is smaller than the spacing between inserts 54d-54e. The intercolumn spacing between inserts 54d-54e and 54e-54f may be the same spacing distance. The intercolumn spacing between inserts 54a-54b, 54b-54c, 54g-54h and 54h-54i may all be the same distance. The intercolumn spacing between inserts 54c-54d and 54f-54g may be smaller than the distance between the inserts 54c-54b or may be larger than the distance between the inserts 54c-54b. The intercolumn spacing between inserts 54c-54d and 54f-54g may also be smaller than the distance between the inserts 54h-54g or may be larger than the distance between the inserts 54h-54g.

The intracolumn spacing between different inserts within a column may also be different for different columns so that intercolumn spacing between inserts in different rows may differ. Such intracolumn spacing may differ so that inserts within columns located in the center region of the wear surface may be spaced further apart than inserts in columns of the wear surface which are located more adjacent to the ends or edges of the wear surface 14, 16. Alternatively, while not shown, inserts within columns located toward the center region of the wear surface may be intracolumnly spaced closer together than inserts in columns of the wear surface which are located more adjacent to the ends or edges of the wear surface 14, 16. In other words, inserts located near the first and second ends 14, 16 of the roller may be spaced apart via intracolumn spacing so that these inserts are much closer to each other or much further from each other relative to the inserts in columns of inserts positioned in the center of the wear surface and center of each row. The intracolumn spacing may couple with the intercolumn spacing to define rows of inserts being closer to inserts of other immediately adjacent rows at the ends 14, 16 of the wear surface as compared to the center region of the wear surface. The center region in contrast may be arranged with much larger spacing between inserts in immediately adjacent rows.

As may be seen from the alternative embodiment shown in FIG. 6, an arrangement of inserts similar to the arrangement shown in FIG. 5 may utilize different sizing and similar spacing of inserts, so that larger diameter or width inserts are located more proximate the ends of the roller wear surface, while inserts having a smaller width or diameter are positioned more proximate the center portion of the wear surface. Arrangements of inserts utilizing larger diameter or larger width inserts near the ends of the wear surface 14, 16 as shown in the embodiment of FIG. 6 may help with the formation and integrity of an autogenous layer of material in the end regions of the wear surface because the larger width or diameter inserts essentially increases the contact surface area with the autogenous layer material. Therefore, the larger inserts located near the ends of the wear surface allow autogenous layer formation and preservation in low pressure conditions that can exist in these locations of the wear surface. Moreover, the larger inserts located near the ends of the wear surface serve as “dams” to keep autogenous layer material in the center of the wear surface and prevent autogenous layer migration along the width of the wear surface.

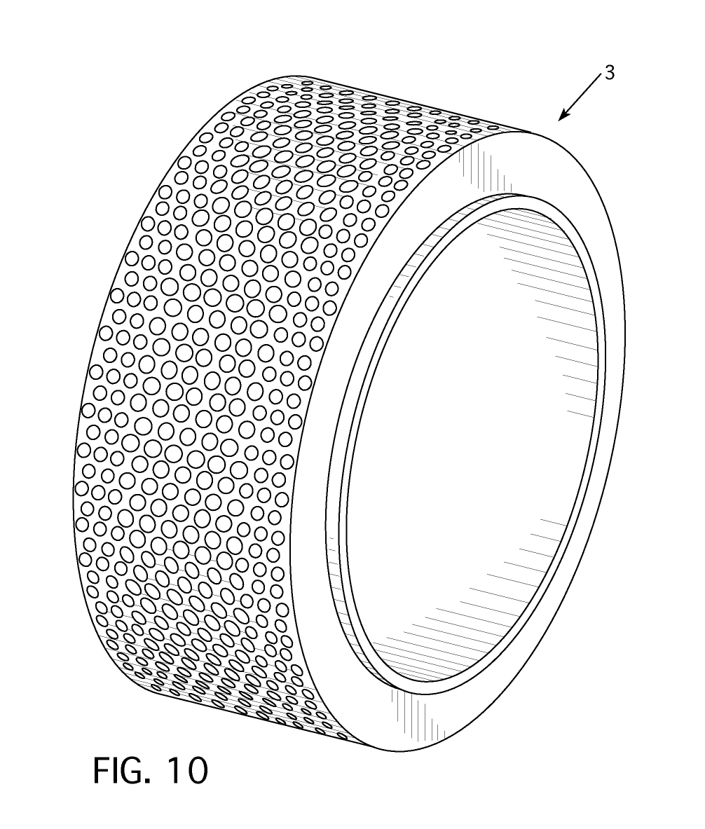

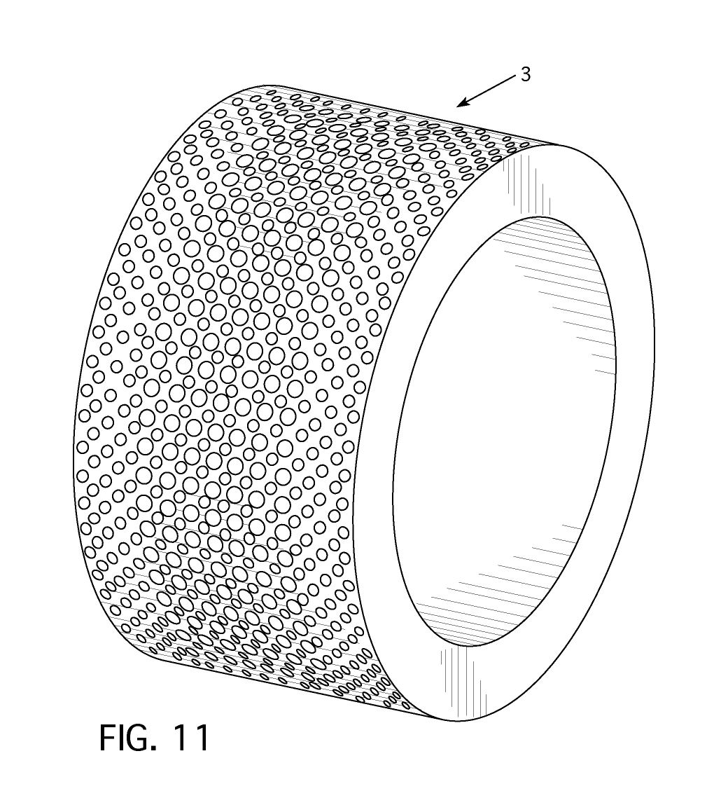

In contrast, embodiments of rollers such as those shown in FIGS. 10 and 11 (discussed more specifically further below) that utilize a wear surface having inserts of smaller widths or diameters with larger spacings located near the ends of the roller wear surface, allowing the possibility of greater autogenous material flow in lower pressure regions, and larger widths or diameters with smaller spacings located in the center or higher pressure region of the wear surface, lessening the possibility of autogenous material flow, may help ensure the formation of an autogenous layer of material across the width of the wear surface while reducing the uneven flow of material and wear across the varying pressure regions of the roller wear surface. Further, the larger width inserts may wear slower than the smaller outside inserts, which may permit wear to be experience more uniformly across the width of the wear surface as well. Such designs may be able to configure the wear surface to lessen any uneven wear that may result in cupping. By maintaining a smaller variance in wear between the edges and central regions of the roller wear surface, the life of the roller wear surface may be extended.

In conventional designs for rollers, the center region of the wear surface typically experiences higher pressures than other areas, and therefore, it usually experiences significantly more wear than other regions of the wear surface (e.g., regions adjacent the ends 14, 16). This phenomenon leads to the roller condition known as “cupping”, which may result in the wear surface having a concave shape on the roller. It is because of these higher central forces, that inserts located in the center region of the wear surface often decrease in width or diameter more quickly than other inserts of the same or larger size which are positioned adjacent the ends 14, 16 of the wear surface. As a result, non-uniform wear patterns can occur, requiring premature maintenance, repair, or replacement of the wear surface. Using larger diameter or width inserts in the center region of the wear surface as discussed above and as shown in the figures may provide improved wear characteristics over conventional designs and slow the onset of cupping.

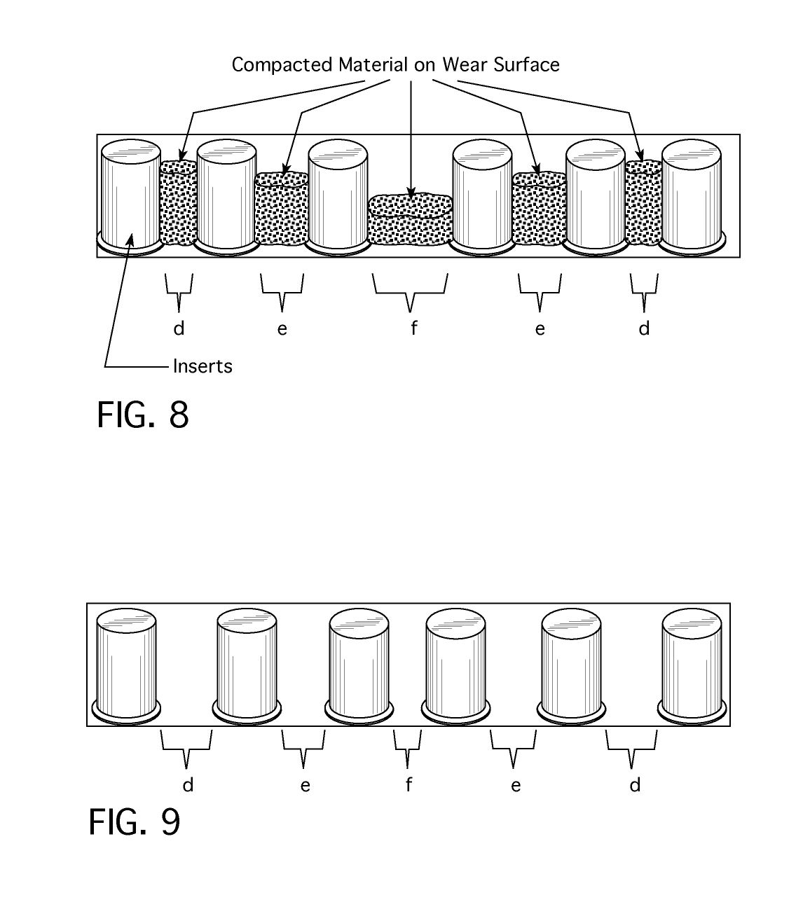

Referring to FIG. 8, the intercolumn spacing between inserts of a row of inserts may be designed so that the spacing d between inserts located near the ends 14, 16 of the wear surface in a row of inserts is smaller than the intercolumn spacing e of inserts located between an end and the center of the wear surface in that same row. The spacing e is less than the spacing f located near the center of the wear surface. The spacing may progressively increase from the ends of the wear surface to the center of the wear surface in order to better stabilize the autogenous layer against migration and prevent premature wear to the roller. For instance, the arrangement of inserts may facilitate the formation of a more homogenous autogenous layer in the spaces d, and e as compared to conventional designs and provide a more uniform layer of compacted material within the spaces between adjacent inserts. A more uniformly thick layer of material compacted on the wear surface may increase the life of the wear surface and also improve the crushing performance of the roller.

Further, the use of narrower intracolumn spacing for columns of inserts positioned near the ends of the wear surface as compared to intracolumn spacing for inserts located in columns in the center region of the wear surface may further enhance the formation of the autogenous layer and wear characteristics of the roller. The intracolumn spacing may progressively increase so that columns positioned intermediate of the center and ends of the wear surface have intracolumn spacings that are larger than endmost columns but smaller than one or more central columns of inserts.

The beneficial compaction and crushing performance provided by intercolumn insert spacing and intracolumn insert spacing used to define rows of inserts may be further enhanced by using inserts of different widths or diameters. The inserts may be arranged so that inserts having a smaller width or diameter are positioned adjacent the ends of the wear surface and inserts of a larger diameter are positioned adjacent the center region of the wear surface. Using larger diameter or larger width inserts towards the center of the wear surface may supply a more durable wear surface in an area of the wear surface that experiences high forces, and may better protect the inserts from breakage (e.g., “chipping” during break-in commissioning period). Using smaller diameter or smaller width inserts toward the ends or outsides of the wear surface enables the inserts to be arranged in a more concentrated fashion to better stop the axial movement of autogenous layer material during comminution, thereby helping retain sacrificial wear material in a central region of the wear surface. Using smaller diameter or smaller width inserts toward the ends 14, 16 or outsides of the wear surface also helps ensure the formation and continued presence of an autogenous layer of material along the ends of the wear surface, as well as maintaining a similar thickness as compared to the autogenous layer material located in the center region of the wear surface.

In alternative embodiments, the intercolumn spacing of inserts may be changed so that inserts within a row may be spaced differently than what is shown in FIG. 8. For example, the inserts may alternatively be arranged so that spacing is larger at the ends of the wear surface relative to the center region of the wear surface. For instance, columns of inserts may be positioned in the wear surface so that rows of inserts are formed such that the distance d between inserts positioned adjacent the ends of the wear surface are spaced farther apart than the spacing e between the intermediate inserts and central inserts. The spacing f between central positioned inserts may be less than or equal to distance e. An example of such an alternative arrangement of inserts in a row of inserts may be appreciated from FIG. 9, which illustrates a row of six inserts positioned along a width w of a roller wear surface. For some embodiments, such an arrangement of rows of inserts may permit material to be accumulated on the wear surface of the roller to form an autogenous layer in the center region of the roller wear surface while also permitting the formation of such a layer near the ends of each wear surface so that the roller may wear more evenly along the width of the wear surface. It should be appreciated that a row of inserts may be configured as having more than or less than six inserts arranged such that spacing between the inserts in the row progressively decreases toward the center of the row.

Embodiments of rollers that utilize insert spacing that is closer at the center of the wear surface relative to the spacing between inserts near the edges of the wear surface may provide a number of advantages. For example, it is contemplated that in certain configurations the wear experienced by the wear surface may be more uniform utilizing such spacing by allowing the ends of the roll surface to wear at a more consistent rate with the center portion. As another example, the space between inserts in the center portions of the roller may be lessened or narrowed to prevent radial movement (e.g. circumferential movement of material) and the spacing of the inserts in end regions of the wear surface may be lessened or narrowed to reduce the axial movement (e.g. movement along the width of the wear surface) at the ends of the roller wear surface to contribute to a formation of an autogenous layer of material along the full width of the wear surface.

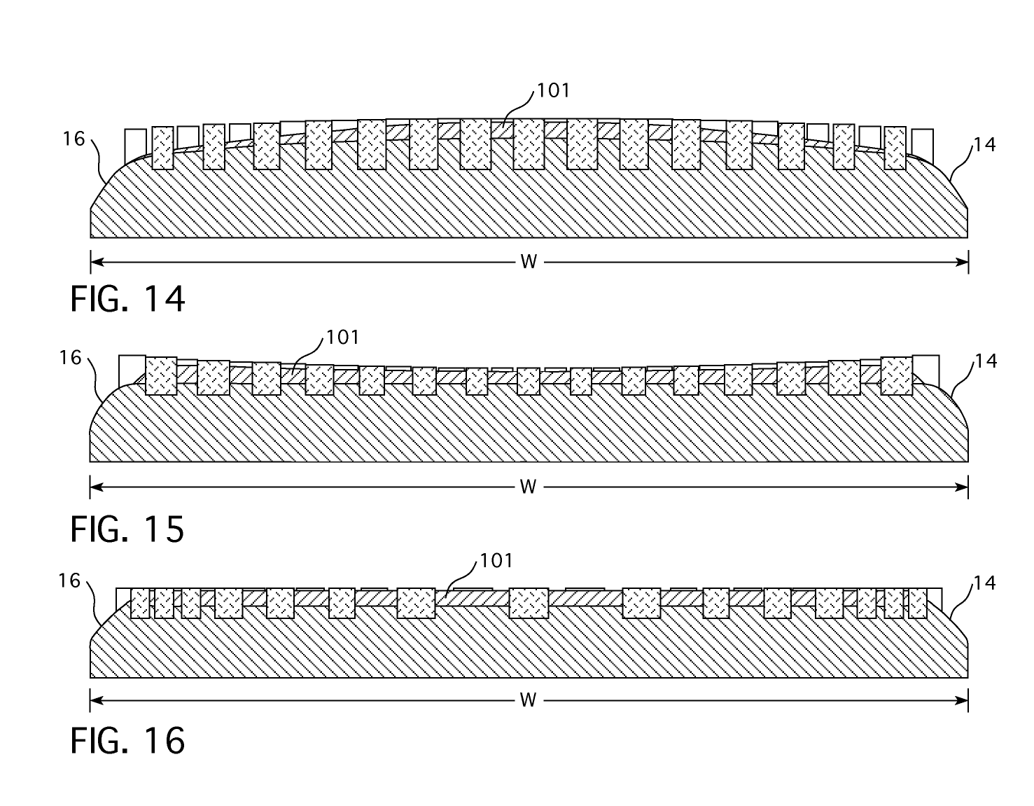

Examples of different autogenous layer formations that may be defined by the insert configuration of an embodiment of a roller may be appreciated from FIGS. 14-16. As noted above, the intercolumn and intracolumn spacing between inserts and the size of the inserts in such columns may define the autogenous layer formation that is created when the roller is utilized in comminution operations. The formation of the autogenous layer of material helps reduce wear on the roller. For instance, inserts that are in columns having the same intercolumn and intracolumn spacing, but have larger sized inserts in the middle of the wear surface of the roller and smaller inserts near the first and second ends 14, 16 of the roller may provide an autogenous layer of material 101 during comminution operations that is convex in shape such that a larger thickness of material is formed in the middle portion of the wear surface of the roller and a smaller layer or no layer is formed adjacent the ends of the roller wear surface. In other embodiments, smaller sized inserts may be located in middle columns of the roller and larger inserts may be positioned near the first and second ends 14, 16 of the roller and the intercolumn and intracolumn spacing may be the same throughout the roller wear surface to propagate the formation of an autogenous layer of material during comminution operations that is concave in profile as may be appreciated from FIG. 15. Such an autogenous layer profile may be configured so that the autogenous layer is thicker near the ends of the roller wear surface and a thinner in the middle of the roller wear surface. As yet another example, the intercolumn and intracolumn spacing of the inserts as well as the size of the inserts may be arranged so that inserts in middle columns are larger and are spaced farther apart from each other than inserts located near the first and second ends 14, 16 of the roller. The arrangement of inserts may propagate an autogenous layer of material 101 that is substantial flat in profile and has a substantially even layer of thickness across the width W of the wear surface of the roller. It should be understood that the autogenous layer that is propagated may depend on the material being comminuted, the size of the inserts, and the spacing of the inserts within the rows and columns of the curved surface area, or wear surface, of the roller.

Referring to FIGS. 10-11, embodiments of rollers 3 are illustrated having insert row and column configurations that utilize tighter spacing between immediately adjacent inserts located in the center region of the wear surface relative to the spacing of inserts provided near the ends of the roller. In addition to such spacing, larger diameter inserts may be located in the middle of the wear surface as shown in FIG. 10 or may be mixed with smaller diameter inserts in the center region of the wear surface as shown in FIG. 11. For the embodiments of FIGS. 10 and 11, the intercolumn spacing of inserts within each row may be closer in the center region of the wear surface as compared to the intercolumn spacing located near the ends of the wear surface. Such spacing may be progressively different so that inserts near each end of the wear surface are farther from each other relative to inserts in the center region of the wear surface, and so that inserts between the center and ends of the wear surface may be spaced closer together than the inserts on the ends of the wear surface, but not as close as the inserts in the center of the wear surface.

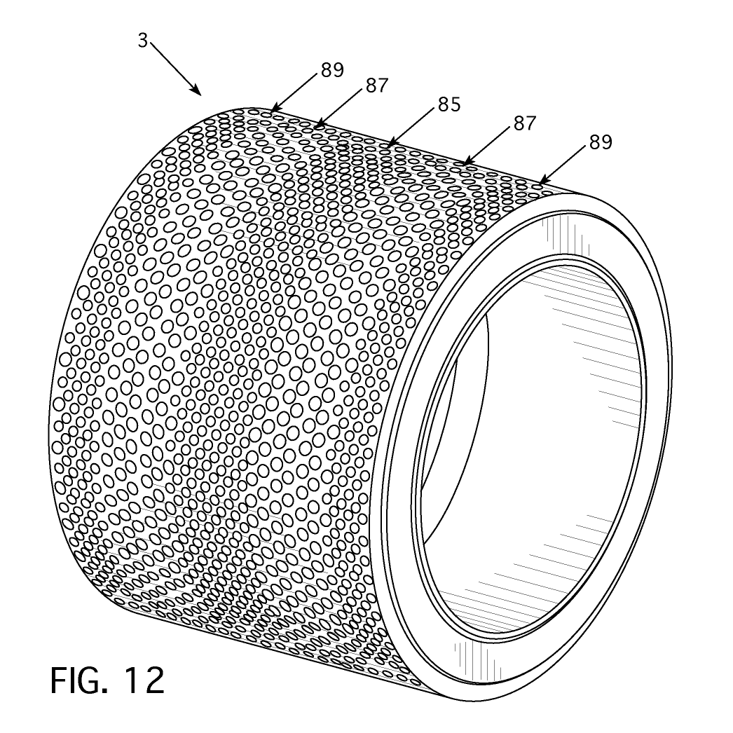

In yet other alternative designs, the inserts may be arranged in columns along the circumference of the roller such that there are columns of inserts 89 near the ends of the roller wear surface having smaller diameter inserts as may be seen in FIG. 12. Central columns of inserts 85 may also have such small sized inserts. Intermediate columns of inserts 87 located between the central and end columns of inserts, however, may be of a larger sized diameter and may also be spaced further apart from each other than the end and middle column inserts. Such a configuration of inserts may provide tight spacing between immediately adjacent inserts near the end and center region of the wear surface while providing a larger spacing between immediately adjacent inserts located in the intermediate zones, or areas between the center and end regions. In some embodiments, the spacing between the inserts in the end regions defined by the end columns of inserts 89 may be closer or farther apart than the spacing of the center region of inserts defined by the central columns 85. In other embodiments, the spacing between immediately adjacent inserts may be the same in both the center and end regions defined by columns of inserts 89 and 85.

The configuration of inserts as illustrated in FIG. 12 may provide a wear surface configuration that contributes to the formation of a desired profile shaped onto the roller wear surface. Rollers that may be designed for use in a roller press or other crusher device that may utilize opposing rollers that are spaced from each other to define a nip or space along which material is compressed by the opposing rollers may then be designed to wear so that profiles are formed that mate, or intermesh with each other.

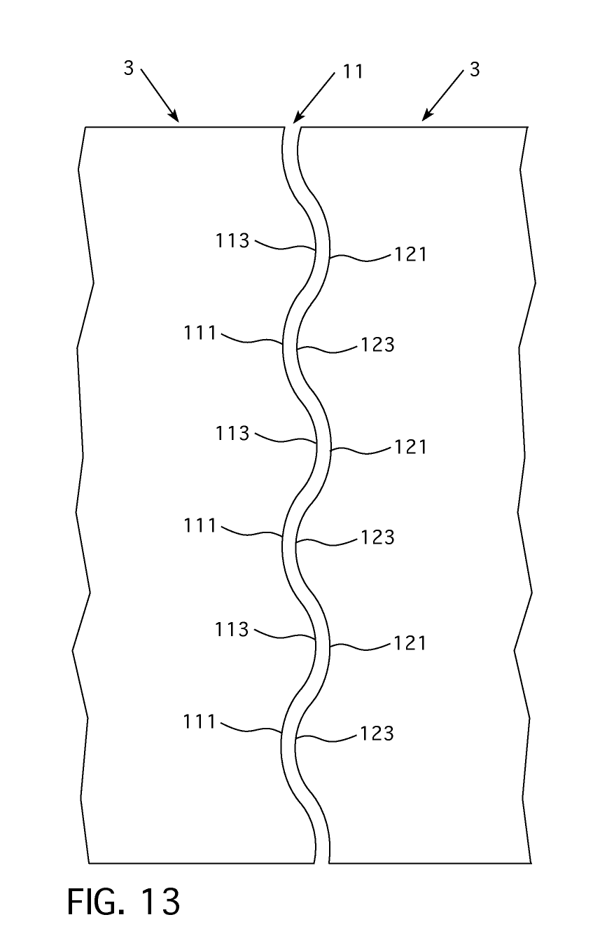

An example of such mating or intermeshing roller wear surfaces may be seen in FIG. 13. The formation of a mating or intermeshing wear profile on each wear surface is yet another approach for establishing and maintaining an autogenous layer while reducing the axial loss of material at the ends of the roll surface.

The roller wear surface may be configured to utilize different sized inserts, different insert spacing and different radial insert depths (e.g. depth within roller body or wear surface) may provide inserts that are spaced and arranged to help mitigate axial flow by resulting in a profile being formed on the wear surface that defines a plurality of recesses in the wear surface surrounded by projecting portions of the wear surface that define these formed recesses. For example, some inserts may be positioned fully within the wear surface so the inserts are only exposed upon the wear surface experience some level of wear while others may be positioned to initially extend out of the roller body.

FIG. 13 illustrates one example of such a profile formed in opposing rollers that may have such recesses 111 and projecting portions 113 that mate or intermesh with recesses 121 and projecting portions 123 formed in an opposing roller wear surface. These recessed and projected portions may cover the entire wear surface or certain strategic portions of the wear surface. Such a mating or intermeshing wear profile in opposing rollers may help contribute to a longer effective life of the wear surface of the rollers and allow the crusher device to operate with better efficiency for a longer period of time as compared to similar devices using rollers having conventional designs.

In yet other contemplated embodiments of the roller, a wear surface may include inserts that are of different diameters adjacent the ends of the roller and have inserts of only one size diameter located in the center region of the wear surface as well. In yet other contemplated alternatives, inserts in the wear surface near the ends of the roller may be of multiple different widths or diameters and inserts near the center of the wear surface may be of multiple different widths or diameters as well. The differing widths and diameters may be the same as the inserts located near the ends of the wear surface or may be different. The spacing between the inserts of such rollers may utilize any of the various different spacing arrangements discussed above.

It should be appreciated that the spacing changes between different columns of inserts may be determined based on a number of factors that are affected by, for example, the composition of ore or other material that is being comminuted, the moisture content of such material, and the feed size of the material being fed to the crushing device. Spacing between inserts in the same row from different columns of inserts and the spacing between inserts in the same column from different rows of inserts is preferably selected for improving the wear life of the roller while also permitting the formation of an autogenous layer or semiautogenous layer of material along the wear surface when the roller rotates to crush material.

A method for making embodiments of rollers for use in crushing devices such as roller presses or roller mills includes a number of steps. First, a roller manufacturer or crushing device manufacturer may offer to build a roller either by offering to build a roller for use in a crushing device or offering to build a crushing device for a customer. Pre feed calculations for a particular material to be comminuted by the roller may be made. The prefeed calculations may be based on the feed sizing, specific gravity, bulk density, moisture content, and composition of the material to be fed into a device for comminution to a desired sizing distribution. A desired throughput rate for feed material and other desired operational parameters for the crushing device may then be determined and the crushing of material may then be tested based on these initial determinations and calculations to better assess comminution characteristics of the material. Post testing analysis may be performed to assess the cake thickness, flake density, bulk density, and size distribution of the comminuted material. The wear experienced during the test comminution may also be assessed to determine an insert arrangement to better address wear experienced during comminution of the material at the desired operating parameters. Thereafter, a specific throughput, energy requirement, and grinding force may be determined for determining a machine and roller size and a desired insert arrangement for providing a desired operational performance while also maximizing the wear life of the rollers for achieving that desired operational performance may be determined. The roller may then be fabricated in accordance with the determined sizing and insert arrangements.

It should be appreciated that embodiments of rollers may be made using a number of different insert arrangements within the scope of the claimed invention. For example, in addition to having different columns of inserts of different widths or diameters, each column of inserts may utilize inserts of different diameters or different widths within the same column of inserts to provide further advantageous wear characteristics when desirable. As another example, the material selected for use in the inserts or roller wear surface could be any of a number of material choices found suitable to meet particular design criteria. As yet another example, embodiments of the rollers may be sized to have any of a number of diameters or wear surface widths for meeting a particular design objective.

While certain present preferred embodiments of crushing devices, a roller for use in crushing devices, and certain embodiments of methods of practicing the same have been shown and described, it is to be distinctly understood that the invention is not limited thereto but may be otherwise variously embodied and practiced within the scope of the following claims.

What is claimed is:

1. A roller for a crushing device, the roller having a first end, a second end opposite the first end, and a wear surface that has a width extending from adjacent to the first end of the roller to adjacent to the second end of the roller, the roller comprising:
a first column of first inserts positioned in the wear surface adjacent to the first end of the roller;
a second column of second inserts positioned in the wear surface;
a third column of third inserts position in the wear surface;
the second column of second inserts being positioned between the first column of first inserts and the third column of third inserts;
a first insert of the first column of first inserts, a second insert of the second column of second inserts and a third insert of the third column of third inserts being positioned within a first row of inserts extending across the width of the wear surface;
the first insert of the first row being spaced apart from the second insert of the first row by a first distance;
the second insert of the first row being spaced apart from the third insert of the first row by a second distance that is greater than or less than the first distance;
the roller of further comprising a fourth column of fourth inserts positioned in the wear surface, a fourth insert of the fourth column of fourth inserts also being in the first row of inserts, the fourth insert of the first row being spaced apart from the third insert of the first row by a third distance that is greater than or less than the first distance.

2. The roller of claim 1 wherein the fourth column of fourth inserts and the third column of third inserts are located in a center portion of the wear surface of the roller and wherein the second distance is greater than the first distance and the second distance is less than the third distance.

3. The roller of claim 2 further comprising a fifth column of fifth inserts positioned in the wear surface and a sixth column of sixth inserts positioned in the wear surface, the sixth column of sixth inserts being positioned adjacent to the second end of the roller, the fifth column of fifth inserts being positioned between the fourth column of fourth inserts and the sixth column of sixth inserts, a fifth insert of the fifth column of fifth inserts and a sixth insert of the sixth column of sixth inserts being within the first row, the fifth insert of the first row being spaced apart from the fourth insert of the first row by the second distance and the sixth insert of the first row being spaced apart from the fifth insert of the first row by the first distance.

4. The roller of claim 1 wherein intracolumn spacing of first inserts of the first column of first inserts is narrower than intracolumn spacing of third inserts of the third column of third inserts; and
wherein intracolumn spacing of the second inserts of the second column of second inserts is narrower than the intracolumn spacing of third inserts of the third column of third inserts; and
wherein the intracolumn spacing of the third inserts of the third column of third inserts is narrower or wider than intracolumn spacing of the fourth inserts of the fourth column of fourth inserts.

5. The roller of claim 3 further comprising:
a seventh column of seventh inserts positioned in the wear surface adjacent the first end of the roller;
an eight column of eight inserts positioned in the wear surface;
a ninth column of ninth inserts positioned in the wear surface, the eighth column of eighth inserts being between the ninth column of ninth inserts and the seventh column of seventh inserts;
a tenth column of tenth inserts positioned in the wear surface;
an eleventh column of eleventh inserts positioned in the wear surface adjacent the second end of the roller, the tenth column of tenth inserts being between the ninth column of ninth inserts and the eleventh column of eleventh inserts;
a seventh insert, an eight insert, a ninth insert, a tenth insert, and an eleventh insert being in a second row of inserts adjacent the first row of inserts, the second row of inserts extending along the width of the wear surface;
the seventh insert of the second row spaced apart from the eight insert of the second row by a fourth distance, the eight insert of the second row spaced apart from the ninth insert of the second row by a fifth distance, the ninth insert of the second row spaced apart from the tenth by the fifth distance and the eleventh insert of the second row spaced apart from the tenth insert of the second row by the fourth distance; and
wherein the fourth distance is less than the fifth distance.

6. The roller of claim 5 wherein the seventh insert of the second row is spaced apart from the first insert of the first row by a sixth distance and wherein the ninth insert of the second row is spaced apart from the third insert of the first row by a seventh distance, the sixth distance being smaller or larger than the seventh distance.

7. The roller of claim 6 wherein the ninth inserts have a larger diameter or width than the eighth inserts and the ninth inserts have a larger diameter or width than the eleventh inserts.

8. The roller of claim 7 wherein the diameter or width of the ninth inserts are equal to the diameter or width of the fourth inserts.

9. The roller of claim 7 wherein the diameter or width of the ninth inserts are larger than the diameter or width of the fourth inserts.

10. The roller of claim 1 wherein each of the first inserts have a diameter or a width and each of the fourth inserts have a diameter or a width, the diameter or width of the first inserts being smaller or larger than the diameter or width of the fourth inserts.

11. The roller of claim 10 wherein each of the third inserts have a width or diameter and the width or diameter of the third inserts is larger or smaller than the diameter or width of the first inserts.

12. The roller of claim 11 wherein the width or diameter of the third inserts is greater than a width or diameter of the second inserts and is also greater than the width or diameter of the first inserts and wherein the width or diameter of the third inserts is smaller than the width or diameter of the fourth inserts.

13. The roller of claim 1 further comprising:
a fifth column of fifth inserts positioned in the wear surface;
a sixth column of sixth inserts positioned in the wear surface, and
a seventh column of seventh inserts positioned in the wear surface;
the seventh column of seventh inserts being positioned adjacent to the second end of the roller, the sixth column of sixth inserts being positioned between the fifth column of fifth inserts and the seventh column of seventh inserts, and the fifth column of fifth inserts being positioned between the fourth column of fourth inserts and the sixth column of sixth inserts;
a fifth insert of the fifth column of fifth inserts, a sixth insert of the sixth column of sixth inserts and a seventh insert of the seventh column of seventh inserts being within the first row, the fifth insert of the first row being spaced apart from the fourth insert of the first row by the third distance, the sixth insert of the first row being spaced apart from the fifth insert of the first row by the second distance and the seventh insert of the first row being spaced apart from the sixth insert of the first row by the first distance; and
the third distance being greater than the second distance and the second distance being greater than the first distance.

14. The roller of claim 13 further comprising:
an eight column of eighth inserts positioned in the wear surface being adjacent the first end of the roller;
a ninth column of ninth inserts positioned in the wear surface;
a tenth column of tenth inserts positioned in the wear surface, the ninth column of ninth inserts being positioned between the tenth column of tenth inserts and the eighth column of eighth inserts;
an eleventh column of eleventh inserts positioned in the wear surface adjacent the second end of the roller, the tenth column of tenth inserts being between the ninth column of ninth inserts and the eleventh column of eleventh inserts;
an eight insert, a ninth insert, a tenth insert, and an eleventh insert being in a second row of inserts adjacent the first row of inserts, the second row of inserts extending along the width of the wear surface;
the eighth insert of the second row spaced apart from the ninth insert of the second row by a fourth distance, the ninth insert of the second row spaced apart from the tenth insert of the second row by a fifth distance and the eleventh insert of the second row spaced apart from the tenth insert of the second row by a sixth distance; and
wherein the fourth distance is less than the fifth distance and the sixth distance is less than the fifth distance.

15. The roller of claim 14 wherein the eighth insert of the second row is spaced apart from the first insert of the first row by a distance that is less than one of:
a length of a space separating the ninth insert of the second row from the fourth insert of the first row and a length of space separating the ninth insert of the second row from the third insert of the first row.

16. A crushing device comprising the roller of claim 1.

17. A method for making a roller for a crushing device comprising:
offering to build a crushing device to comminute material;
assessing grinding forces, feed material sizing, moisture content of the feed material, and composition of the feed material;
making calculations to determine parameters of the crushing device needed for comminuting the material;
determining a desired throughput rate for the crushing device;
analyzing parameters of the material after being comminuted in a testing device;
assessing wear characteristics of rollers for the crushing device;
designing the rollers of the crushing device to have a wear surface to account for the analyzed parameters of the material after being comminuted in the testing device, the calculated grinding forces, and the assessed wear characteristics for the rollers to determine positioning of inserts in a wear surface for each roller; and
making the rollers, each of the rollers comprising:
a first column of first inserts positioned in a wear surface adjacent to a first end of the roller,
a second column of second inserts positioned in the wear surface,
a third column of third inserts position in the wear surface,
the second column of second inserts being positioned between the first column of first inserts and the third column of third inserts,
a first insert of the first column of first inserts, a second insert of the second column of second inserts and a third insert of the third column of third inserts being positioned within a first row of inserts extending across the width of the wear surface,
the first insert of the first row being spaced apart from the second insert of the first row by a first distance, and
the second insert of the first row being spaced apart from the third insert of the first row by a second distance that is greater than or less than the first distance.

18. The method of claim 17 wherein the rollers are made such that each of the rollers also comprises a fourth column of fourth inserts positioned in the wear surface, a fourth insert of the fourth column of fourth inserts also being in the first row of inserts, the fourth insert of the first row being spaced apart from the third insert of the first row by a third distance that is greater than the first distance.

19. A roller for one of a roller press and a roller mill, the roller having a first end, a second end opposite the first end, and a wear surface that has a width extending from adjacent to the first end of the roller to adjacent to the second end of the roller, the roller comprising:
a generally cylindrical body having a bore sized and configured to receive at least a portion of at least one axle of the one of the roller press and the roller mill about which the roller is rotatable, the body having a first end, a second end opposite the first end, and a wear surface extending between adjacent the first end and adjacent the second end;
a plurality of inserts positioned in the wear surface, the inserts comprising first inserts in a first region of the wear surface located adjacent the first end, second inserts located in a second region of the wear surface located adjacent the second end, and third inserts located in a third region of the wear surface between the first and second inserts, each of the first inserts positioned away from immediately adjacent other first inserts by a first distance, each of the second inserts positioned away from immediately adjacent other second inserts by the first distance, each of the third inserts positioned away from immediately adjacent other third inserts by a second distance, the second distance being less than or greater than the first distance.

20. The roller of claim 19 wherein the second distance is less than the first distance.

21. The roller of claim 19 wherein the second distance is greater than the first distance.

22. The roller of claim 19 wherein the third inserts are comprised of inserts having a first diameter and inserts having a second diameter that is larger than the first diameter and wherein the first and second inserts are comprised of inserts having the first diameter.

23. The roller of claim 19 wherein the inserts are further comprised of fourth inserts and fifth inserts, the fourth inserts being located in a fourth region on the wear surface that is positioned between the first region and the third region and the fifth inserts being positioned in the wear surface in a fifth region located between the third region and the second region.

24. The roller of claim 23 wherein each of the fourth inserts are spaced apart from other immediately adjacent fourth inserts by a third distance and wherein each of the fifth inserts are spaced apart from immediately adjacent other fifth inserts by the third distance, the third distance being greater than or less than at least one of the first distance and the second distance.

25. The roller of claim 24 wherein the third distance is greater than both the first distance and the second distance.

26. The roller of claim 24 wherein the third distance is less than the first distance and greater than the second distance.
